(19) United States
(12) Patent Application Publication
(10) Pub. No.: US 2005/0181100 A1
(43) Pub. Date: Aug. 18, 2005

(54) Frozen layered food product

(75) Inventors: Sandro Panaioli, Cisterna di Latina (IT); Michela Tamai, Cisterna di Latina (IT); Massimiliano Treggiari, Cisterna di Latina (IT); Alexander Armand White, Cisterna di Latina (IT)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods North America, Division of Conopco, Inc.

(21) Appl. No.: 11/058,825

(22) Filed: Feb. 16, 2005

(30) Foreign Application Priority Data
Feb. 16, 2004 (EP) 04250803.6

(51) Int. Cl. A23G 1/00

(52) U.S. Cl. 426/100

(57) ABSTRACT

A process for manufacturing a frozen layered food product comprising the steps of: providing a first pre-frozen composite sheet comprising a sheet of a first ingredient, the sheet of first ingredient including a first upper face and first lower face, the sheet of first ingredient coated on at least one of the first upper and first lower faces with a first filling; and providing a second pre-frozen composite sheet comprising a sheet of a second ingredient, the sheet of second ingredient including a second upper face and second lower face, the sheet of second ingredient coated on at least one of the second upper and second lower faces with a second filling; wherein the first upper face and second lower face are in opposition.

The present invention relates to a frozen layered food product, a process for manufacturing the said food product and apparatus for manufacturing the said food products. The invention relates, in particular, to frozen lasagne.

The advent of ready prepared meals is now an integral part of the modern consumer's lifestyle permitting them to spend more time at work or at leisure. However the increasing demands of modern living require ready prepared meals which can be reheated more quickly.

Frozen lasagne is available as a ready meal. A problem with known frozen lasagne is the length of time taken for reheating which is typically 45 minutes in a convection oven or 8-9 minutes in a microwave oven. The inventors have provided a frozen lasagne which can be reheated in a reduced time by producing a lasagne which permits air between the various layers of ingredients which make up a lasagne to increase heat transfer.

### SUMMARY OF THE INVENTION

Thus is a first aspect of the invention, a process for manufacturing a frozen layered food product is provided comprising the steps of: providing a first pre-frozen composite sheet comprising a sheet of a first ingredient and a first filling, the sheet of first ingredient including a first upper face and first lower face, the sheet of first ingredient coated on at least one of the first upper and first lower faces with a first filling; and providing a second pre-frozen composite sheet comprising a sheet of a second ingredient and a second filling, the sheet of second ingredient including a second upper face and second lower face, the sheet of second ingredient coated on at least one of the second upper and second lower faces with a second filling; and placing the second composite sheet on top of the first composite sheet, wherein the first upper face and second lower face are in opposition.

The first and second ingredient may be selected from dried pasta, cooked pasta, raw aubergine, cooked aubergine, raw zucchini, cooked zucchini, raw meat, cooked meat, fruit, cooked fruit. Optionally the first and second ingredients are identical.

The first and second fillings may be selected from ragout, vegetable stew, meat stew cheese, any combination of the foregoing, and fruit stew. Optionally the first and second fillings are identical.

The process may comprise the additional step of providing a first layer of sauce in opposition to the first lower face. The layer of sauce may be selected from bechamel, savoury and sweet.

The process may comprise the additional step of providing a first layer of cheese in opposition to the second upper face. The cheese is preferably parmesan cheese.

In a second aspect of the invention, a frozen layered food product manufactured in accordance with the process is provided.

In a third aspect of the invention, an apparatus for manufacturing a frozen layered food product is provided, the apparatus comprising a first conveyor comprising a plurality of first trays, each first tray conveying a sheet of food ingredient, a station for dosing a filling onto one face of a sheet of food ingredient thereby to form a composite sheet, a first freezer to freeze a composite sheet thereby to form a frozen composite sheet, a means for guiding a frozen composite sheet onto a first tray at an upstream location on the conveyor, the said means suitable for guiding an nth frozen composite sheet onto an (n−1)th frozen composite sheet at the upstream or a downstream location thereby to form a layered food product, and a second freezer for freezing the layered food product, the second freezer located downstream of the downstream location. n is any whole integer.

The apparatus may additionally comprise a first sauce station for dosing with a layer of sauce a first tray upstream of the said upstream location.

The apparatus may further comprise a first cheese station for dosing with a layer of cheese a face of a composite sheet in a first tray between the said upstream location and the downstream location.

The apparatus may also comprise a second cheese station for dosing with a layer of cheese a face of a composite sheet in a first tray between the said downstream location and the second freezer.

The station for dosing a filling comprises a second conveyor preferably comprises a plurality of second trays each adapted to convey a sheet of ingredient, each second tray comprising side walls which pivot between a first position in the plane of the base of the second tray and a second position wherein the edge of the side walls distal from the base of the second tray is raised above the plane of the base, and a means of raising the side walls from the first to the second position thereby to retain the filling on the sheet of ingredient prior to freezing of the composite sheet.

### BRIEF DESCRIPTION OF THE FIGURES

The invention will now be illustrated with reference to the figures in which:

FIG. 1 shows an embodiment of the frozen layered food product of the invention; and

FIG. 2 shows an apparatus for manufacturing the embodiment of layered food product of the invention illustrated in FIG. 1.

### DETAILED DESCRIPTION

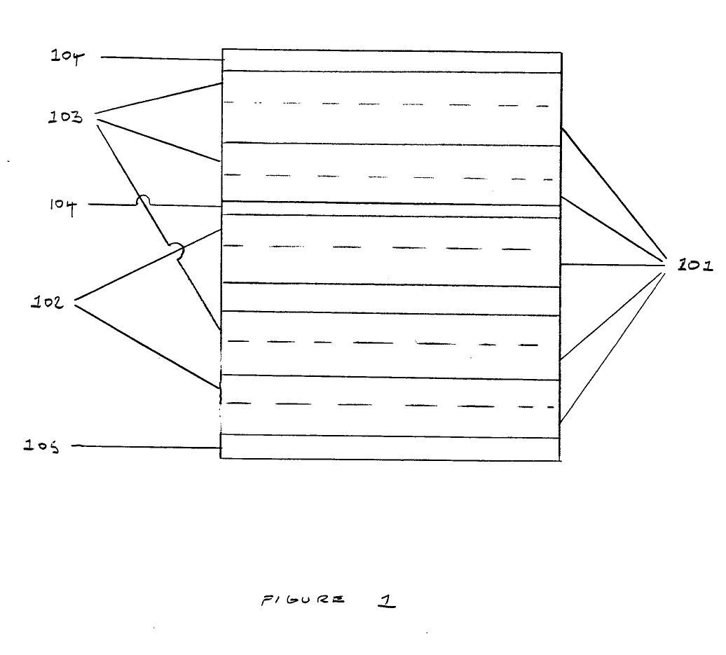

In FIG. 1 a frozen lasagne comprises five layers, each layer comprising cooked pasta sheet (101) and mozzarella cheese/bechamel sauce (102) or cooked pasta sheet (101) and vegetable mix/bechamel sauce (103). The lasagne additionally includes a bottom layer of bechamel sauce (105) and layers of parmesan cheese (104) between the third layer from the bottom and the fourth layer from the bottom, and on top of the fifth layer from the bottom.

The proportions of constituents in the lasagne comprise, numbering the layers from the bottom:

| | | % w/w |
|---|---|---|
| bottom layer | parmesan cheese | 7 |
| first layer | cooked pasta sheet | 5 |
| | mozzarella cheese/bechamel sauce | 11 |
| second layer | cooked pasta sheet | 5 |
| | vegetable mix/bechamel sauce | 11 |
| third layer | cooked pasta sheet | 5 |
| | mozzarella cheese/bechamel sauce | 11 |
| middle layer | parmesan cheese | 2 |
| fourth layer | cooked pasta sheet | 5 |
| | vegetable mix/bechamel sauce | 11 |
| fifth layer | cooked pasta sheet | 5 |
| | vegetable mix/bechamel sauce | 20 |
| top layer | parmesan cheese | 2 |

The pasta is prepared from:

| | % w/w |
|---|---|
| semolina | 74.2000 |
| water | 0.3000 |
| egg | 22.1850 |
| spinach | 3.3150 |

in the usual way. The pasta is formed into sheets by extrusion and then cooked in salted water.

The bechamel sauce is prepared from:

| | % w/w |
|---|---|
| sunflower oil | 2.9645 |
| wheat flour | 2.9645 |
| water | 80.0403 |
| skimmed milk powder | 8.5969 |
| salt | 0.9634 |
| nutmeg | 0.0237 |
| cream | 4.4467 |

in the usual way.

The mozzarella cheese/bechamel sauce consists of 50% w/w of each component.

The vegetable mix is prepared by cooking the following ingredients together at 100 degrees Centigrade:

| | Kg |
|---|---|
| Roasted diced aubergines | 25.381 |
| Roasted diced zucchini | 25.381 |
| Peas | 15.228 |
| Diced pepperoni | 11.421 |
| Diced asparagus | 11.421 |
| Diced carrots | 7.614 |
| Sunflower oil | 5.076 |
| Salt | 0.264 |

The vegetable mix/bechamel sauce consists of 76.92% w/w vegetable mix and 23.08% w/w bechamel sauce.

The frozen lasagne can be reheated in a convection oven in 20 minutes and in a microwave oven in 5-6 minutes.

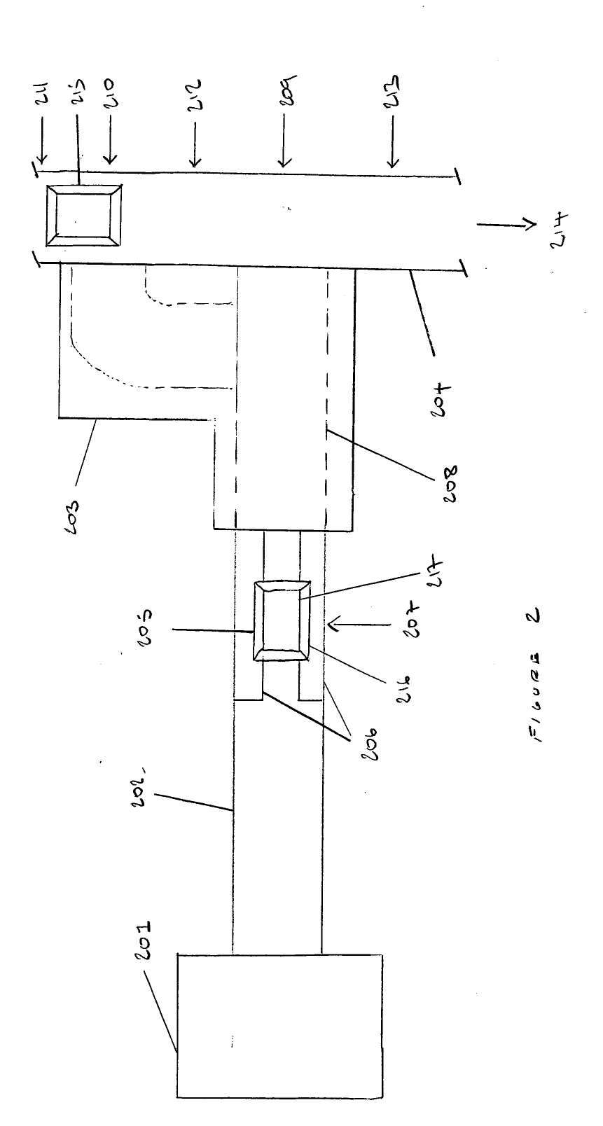

FIG. 2 shows an apparatus for manufacturing the frozen layered food product illustrated in FIG. 1, the apparatus comprising a pasta sheet preparation station (201), a first conveyor (202) comprising a plurality (only one shown) of first trays (205), a first freezer (203), a second conveyor (204) comprising a plurality (only one shown) of second trays (215) and a second freezer (214).

In use, pasta sheets are prepared in the pasta sheet preparation station (201) and each sheet is conveyed along the first conveyor (202) in a first tray (205) towards a pair of flap lifting rails (206). Each first tray comprises a base (217) and pivoting side walls (216). The rails (206) lift the edge of the pivoting side walls (216) distal from the base of each first tray above the plane of the base thereby to provide means for retaining any first tray contents within the first tray.

A filling comprising either mozzarella cheese/bechamel sauce or vegetable mix/bechamel sauce at 85-90 degrees Centigrade is dosed onto each pasta sheet at a filling station (207). Thereafter, each pasta sheet and filling, known as a composite sheet, is conveyed to the first freezer (203) and frozen at −30 degrees Centigrade.

Each frozen composite sheet is then guided by conveyors to an upstream location (210) on the second conveyor or a downstream location (209) on the second conveyor.

The frozen layered food product illustrated in FIG. 1 is assembled in the following manner. Bechamel sauce at 85-90 degrees Centigarde is dosed onto one second tray (215) at a first sauce station (211) upstream of the upstream location (210).

The second tray is then conveyed to the upstream location (210) where three frozen composite sheets are guided in succession to the second tray thereby to form the first three layers of the layered food product illustrated in FIG. 1.

The second tray is then conveyed to a first cheese station (212) where parmesan cheese is added to the top of the third layer.

The second tray is then conveyed further to the downstream location (209) where two further frozen composite sheets are added on top of the third layer in accordance with the layered food product illustrated in FIG. 1.

The second tray is then conveyed to a second cheese station (213) where a second layer of parmesan cheese is added in accordance with the layered food product illustrated in FIG. 1.

The second tray is then conveyed to the second freezer (214) where it is frozen at −30 degrees Centigrade.

1. A process for manufacturing a frozen layered food product comprising the steps of: providing a first pre-frozen composite sheet comprising a sheet of a first ingredient and a first filling, the sheet of first ingredient including a first upper face and first lower face, the sheet of first ingredient coated on at least one of the first upper and first lower faces with a first filling; providing a second pre-frozen composite sheet comprising a sheet of a second ingredient and a second filling, the sheet of second ingredient including a second upper face and second lower face, the sheet of second ingredient coated on at least one of the second upper and second lower faces with a second filling; and placing the second composite sheet on top of the first composite sheet, wherein the first upper face and second lower face are in opposition.

2. A process according to claim 1 wherein the first and second ingredient is selected from dried pasta, cooked pasta, raw aubergine, cooked aubergine, raw zucchini, cooked zucchini, raw meat, cooked meat, fruit, cooked fruit.

3. A process according to claim 2 wherein the first and second ingredients are identical.

4. A process according to claim 1 wherein the first and second fillings are selected from ragout, vegetable stew, meat stew cheese, any combination of the foregoing, and fruit stew.

5. A process according to claim 4 wherein the first and second fillings are identical.

6. A process according to claim 1 comprising the additional step of providing a first layer of sauce in opposition to the first lower face.

7. A process according to claim 6 wherein the layer of sauce is selected from bechamel, savoury and sweet.

8. A process according to claim 1 comprising the additional step of providing a first layer of cheese in opposition to the second upper face.

9. A process according to claim 8 wherein the cheese is parmesan cheese.

10. A frozen layered food product manufactured in accordance with the process of claim 1.

11. An apparatus for manufacturing a frozen layered food product, the apparatus comprising a first conveyor comprising a plurality of first trays, each first tray conveying a sheet of food ingredient, a station for dosing a filling onto one face of a sheet of food ingredient thereby to form a composite sheet, a first freezer to freeze a composite sheet thereby to form a frozen composite sheet, a means for guiding a frozen composite sheet onto a first tray at an upstream location on the conveyor, the said means suitable for guiding an nth frozen composite sheet onto an (n−1)th frozen composite sheet at the upstream or a downstream location thereby to form a layered food product, and a second freezer for freezing the layered food product, the second freezer located downstream of the downstream location.

12. An apparatus according to claim 11 additionally comprising a first sauce station for dosing with a layer of sauce a first tray upstream of the said upstream location.

13. An apparatus according to claim 11 additionally comprising a first cheese station for dosing with a layer of cheese a face of a composite sheet in a first tray between the said upstream location and the downstream location.

14. An apparatus according to claim 11 additionally comprising a second cheese station for dosing with a layer of cheese a face of a composite sheet in a first tray between the said downstream location and the second freezer.

15. An apparatus according to claim 11 wherein the station for dosing a filling comprises a second conveyor comprising a plurality of second trays each adapted to convey a sheet of ingredient, each second tray comprising side walls which pivot between a first position in the plane of the base of the second tray and a second position wherein the edge of the side walls distal from the base of the second tray is raised above the plane of the base, and a means of raising the side walls from the first to the second position thereby to retain the filling on the sheet of ingredient prior to freezing of the composite sheet.
